(19) United States
(12) Patent Application Publication
(10) Pub. No.: US 2012/0230508 A1
(43) Pub. Date: Sep. 13, 2012

(54) EARPHONE, SWITCHING SYSTEM AND SWITCHING METHOD

(75) Inventors: CHIA-WANG CHUANG, Tu-Cheng (TW); HAI-CHAO YANG, Shenzhen City (CN); QIAN WEI, Shenzhen City (CN); JIE ZHENG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD ., Shenzhen City (CN)

(21) Appl. No.: 13/232,445

(22) Filed: Sep. 14, 2011

(30) Foreign Application Priority Data
Mar. 8, 2011 (CN) 201110055774.0

(51) Int. Cl. H04R 1/10

(52) U.S. Cl. 381/74

(57) ABSTRACT

A earphone which can communicate with an electronic device includes a sensing unit, a determining unit and a communication unit. The sensing unit detects a rotation of the earphone to generate a direction signal and to obtain a rotating angle. The determining unit determines whether the rotating angle is at least a predetermined angle and generates a rotating signal when the rotating angle is at least a predetermined angle. The communication unit controls the electronic device to execute different operations.

### BACKGROUND

1. Technical Field

The present disclosure relates to switching systems, and particularly to a switching system with a wireless earphone.

2. Description of Related Art

Hand-held electronic devices, such as mobile phones, always include a earphone for listening to music or receiving a call. By pressing one or more buttons of the earphone, the hand-held electronic devices can switch between “playing music” function and “receiving a call” function. However, when both hands of a user are occupied with something else such as driving a car, it may be inconvenient for the user to press the button on the earphone to switch the functions of the electronic device.

Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout two views.

FIG. 1 is a block diagram of the switching system in accordance with one embodiment.

FIG. 2 is a flowchart of a switching method in accordance with one embodiment.

### DETAILED DESCRIPTION

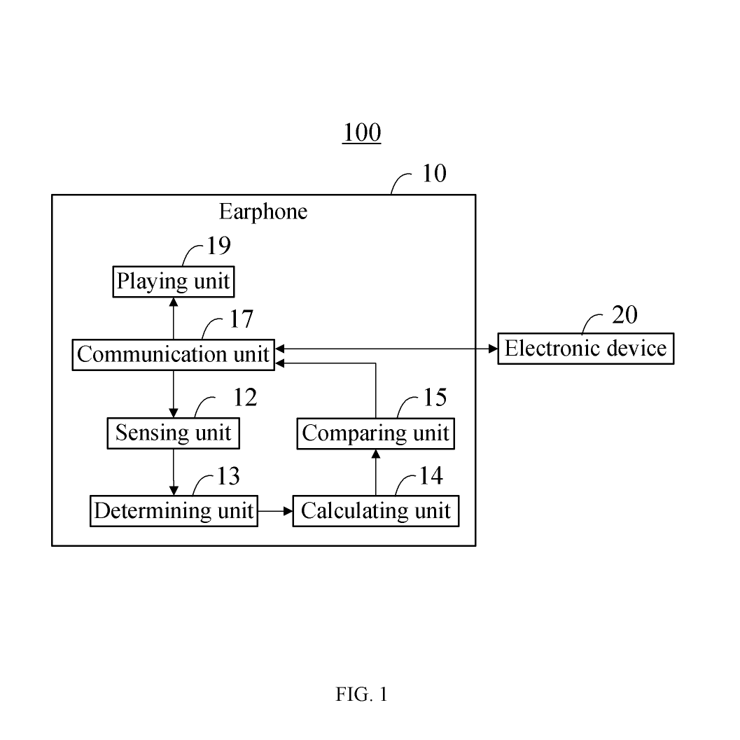

Referring to FIG. 1, a switching system 100 includes an earphone 10 and an electronic device 20. The earphone 10 can communicate with the electronic device 20 in a wireless or a wired manner, and act as a remote for controlling the operations of the electronic device 20. For example, the earphone 10 controls the electronic device 20 to switch between different functions, such as “playing music” function and “receiving a call” function. In the embodiment, the electronic device 20 is a mobile phone. In other embodiments, the electronic device 20 can be a computer, a PDA, or a video player, for example.

The earphone 10 is portable. The earphone 10 detects rotations of the earphone 10 and controlling the operations of the electronic device 20 based on the detected rotations. The earphone 10 includes a sensing unit 12, a determining unit 13, a calculating unit 14, a comparing unit 15, a communication unit 17, and a playing unit 19.

The sensing unit 12 is used for detecting whether the rotations of the earphone 10 is in a predetermined direction and generating a direction signal if the rotation of the earphone 10 is in a predetermined direction. In the embodiment, the sensing unit 12 is a gyro sensor and the sensing unit 12 defines a first predetermined direction and a second direction. When the earphone 10 rotates in a first predetermined direction, the sensing unit 12 generates a first signal. When the earphone 10 rotates in a second predetermined direction different from the first predetermined direction, the sensing unit 12 generates a second signal. When the sensing unit 12 generates the first signal and the second signal continuously and alternatively, one of the first signals or the second signals which is first detected is determined to be the direction signal. For example, the earphone 10 first rotates in the first predetermined direction, and then rotates back in the second predetermined direction. The sensing unit 12 first generates a first signal according to the rotation of the earphone 10 in the first predetermined direction, and then generates a second signal according to the rotation of the earphone 10 in the second predetermined direction. Because the sensing unit 12 first generates the first signal, the first signal is determined to be the direction signal. The sensing unit 12 further detects the rotations of the earphone 10 to obtain a rotating angle of the earphone 10.

The determining unit 13 is used for determining whether the obtained rotating angle is at least a predetermined angle and generating a rotating signal when the rotating angle is at least the predetermined angle. In the embodiment, the predetermined angle can be set by the user.

The calculating unit 14 is used for calculating the number of the generated rotating signals during a predetermined time. In the embodiment, the predetermined time can be set by the user.

The comparing unit 15 is used for comparing the number with a predetermined value and generating control signals based on the comparing result. In the embodiment, when the number of the generated rotating signal is less than the predetermined value, the comparing unit 15 generates a first control signal. When the number of the generated rotating signal is at least the predetermined value, the comparing unit 15 generates a second control signal.

The communication unit 17 is used for transmitting control signals and direction signals to the electronic device 20 and receiving audio signals from the electronic device 20. In the embodiment, the communication unit 17 communicates with the electronic device 20 in a wireless manner.

The playing unit 19 is used for playing the audio signals received from the electronic device 20.

The electronic device 20 receives the direction signal and the control signals from the earphone 10 and executes corresponding operations based on the receiving direction signals and control signals. In the embodiment, when receivingthe first direction signal and the first control signal, the electronic device 20 establishes a phone call. When received the first direction signal and the second control signal, the electronic device 20 disconnects the phone call. When receiving the second direction signal and the first control signal, the electronic device 20 plays music. When receiving the second direction signal and the first control signal, the electronic device 20 pauses the process of playing music.

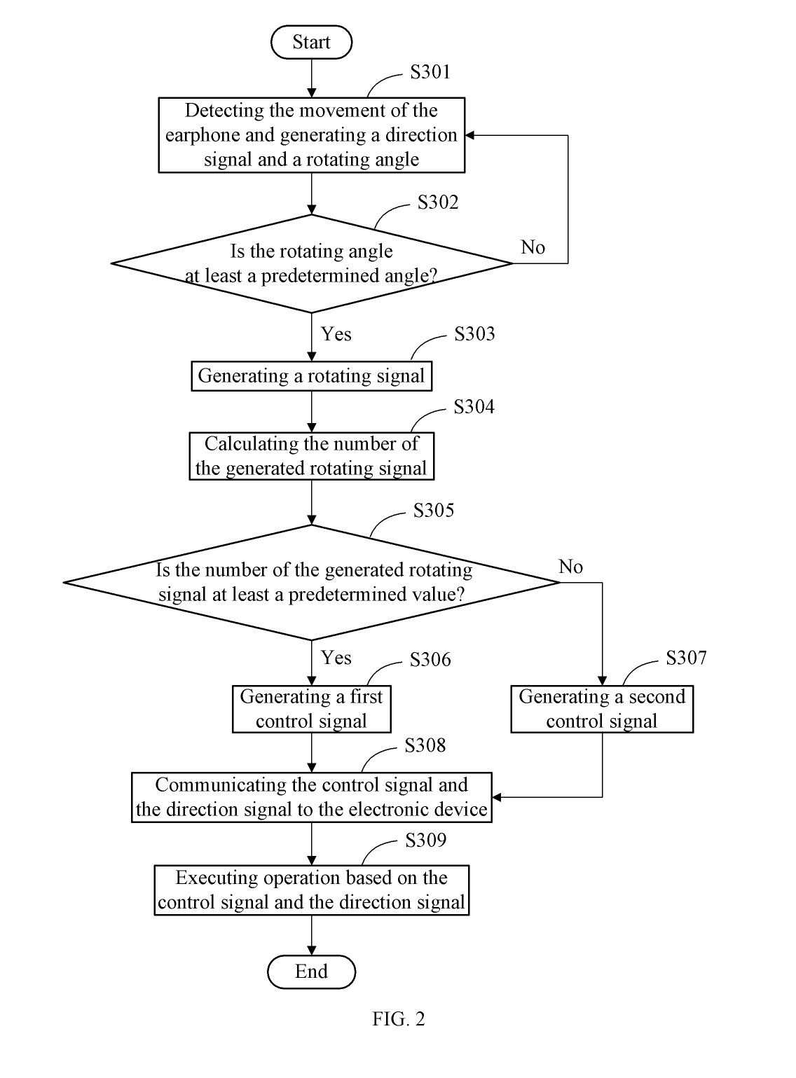

Referring to FIG. 2, a switching method is used for executing different operations of an electronic device 20 based on the rotation of the earphone 10. The switching method includes the following steps.

In step S301, the sensing unit 12 detects rotation of the earphone 10 and respectively generates a direction signal and obtains a rotating angle.

In step S302, the determining unit 13 determines whether the rotating angle is at least a predetermined angle. If the rotating angle is less than the predetermined angle, the procedure returns to step S301; if the rotating angle is at least the predetermined angle, the sensing unit 12 generates a rotating signal and the procedure goes to step S303. In the embodiment, the predetermined angle can be set by the user.

In step S303, the determining unit 13 generates a rotating signal.

In step S304, the calculating unit 14 calculates the number of the generated rotating signals during a predetermined time. In the embodiment, the predetermined time can be set by the user.

In step S305, the comparing unit 15 compares the number with a predetermined value and generates a control signal based on the compared result. In the embodiment, if the number of the generated rotating signals is less than the predetermined value, the procedure goes to step S306; if the number of the generated rotating signals is at least the predetermined value, the procedure goes to step S307.

In step S306, the comparing unit 15 generates a first control signal and the procedure goes to step S308.

In step S307, the comparing unit 15 generates a second control signal and the procedure goes to step S308.

In step S308, the communication unit 17 transmits the direction signals and the control signals to the electronic device 10.

In step S309, the electronic device 10 executes corresponding operation based on the received direction signal and the control signal. In the embodiment, when receiving the first direction signal and the first control signal, the electronic device 20 establishes a phone call. When receiving the first direction signal and the second control signal, the electronic device 20 disconnects the phone call. When receiving the second direction signal and the first control signal, the electronic device 20 plays music. When receiving the second direction signal and the first control signal, the electronic device 20 pauses the process of playing music.

As described, the earphone 10 can control the electronic device 20 to execute operations by moving the earphone 10 without pressing the buttons on the earphone.

It is to be understood, however, that even though information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. A earphone communicating with an electronic device, the earphone comprising:
a sensing unit adapted to detect rotation of the earphone to generate direction signal and a rotating angle;
a determining unit adapted to determine whether the obtained rotating angle is at least a predetermined angle and generate a rotating signal if the rotating angle is at least the predetermined angle; and
a communication unit adapted to control the electronic device to execute different operations according to the direction signal and the rotating signal.

2. The earphone of claim 1, further comprising a calculating unit and a comparing unit, wherein the calculating unit calculates the number of the generated rotating signal during a predetermined time, the comparing unit compares the number with a predetermined value and generates a control signal based on the compared result, the communication unit controls the electronic device to execute different operations according to the different control signal.

3. The earphone of claim 2, wherein the comparing unit generates a first control signal when the number of the generated rotating signal is less than the predetermined value, and generates a second control signal when the number of the generated rotating signal is at least the predetermined value, the comparing unit generates a second control signal different from the first control signal.

4. The earphone of claim 3, wherein when the earphone rotates in a first predetermined direction, the sensing unit generates a first signal; when the earphone rotates in a second predetermined direction different from the first predetermined direction, the sensing unit generates a second signal different from the first signal, the communication unit controls the electronic device to execute different operations according to the first signal and the second signal.

5. The earphone of claim 4, wherein when the sensing unit generates the first signal and the second signal continuously and alternatively, one of the first signal and the second signal whichever is first to be detected is determined to be the direction signal.

6. The earphone of claim 1, wherein the sensing unit is a gyro sensor.

7. The earphone of claim 1, wherein the earphone connects with the electronic device in a wireless manner.

8. The earphone of claim 1, further comprising a playing unit, wherein the playing unit plays the audio signals received from the electronic device.

9. A switching method using between an earphone and an electronic device comprising:
detecting the rotations of the earphone to generate direction signals and a rotating angle;
determining the obtained rotating angle with a predetermined angle and generating a rotating signal if the obtained rotating angle is at least the predetermined angle; and
executing different operations according to the direction signal and rotating signal.

10. The switching method of claim 9, wherein determining the obtained rotating angle with a predetermined angle and generating a rotating signal if the obtained rotating angle is at least the predetermined angle further comprising:
calculating the number of the generated rotating signal during a predetermined time; and
comparing the number with a predetermined value and generating a control signal based on the compared result.

11. The switching method of claim 10, wherein comparing the number with a predetermined value and generating a control signal based on the compared result further comprising:
generating a first control signal if the number is less than the predetermined value; and
generating a second control signal different from the first control signal if the number of the generated rotating signal is at least the predetermined value.

12. The switching method of claim 9, wherein detecting the rotations of the earphone to generate direction signals and to obtain a rotating angle further comprising:
generating a first signal if the earphone rotates in a first predetermined direction; and
generating a second signal different from the first signal if the earphone rotates in a second predetermined direction.

13. The switching method of claim 12, wherein the second predetermined direction is different from the first predetermined direction.

14. The switching method of claim 12, wherein when the first signal and the second signal are generated continuously and alternatively, one of the first signal and the second signal whichever is first to be detected is determined to be the direction signal.

15. The switching method of claim 12, wherein if the rotations of the earphone is not in the first predetermined direction and not in the second predetermined direction, no signal is generated.

16. A switching system comprising:
a earphone adapted to rotate according to the operation of users;
a sensing unit adapted to detect rotation of the earphone to generate direction signal and a rotating angle;
a determining unit adapted to determine whether the obtained rotating angle is at least a predetermined angle and generate a rotating signal if the rotating angle is at least the predetermined angle; and
an electronic device executes different operations according to the direction signal and the rotating signal.

17. The switching system of claim 16, further comprising a calculating unit and a comparing unit, wherein the calculating unit calculates the number of the rotating signal in a predetermined time, the comparing unit compares the number with a predetermined value and generates a control signal based on the compared result, the electronic device executes different operations according to the control signal.

18. The switching system of claim 16, wherein the sensing comprises a first predetermined direction and a second predetermined direction, the sensing unit generates a first signal and a second signal respectively according to the first predetermined direction and the second predetermined direction; when the sensing unit generates the first signal and the second signal continuously and alternatively, one of the first signal and the second signal whichever is first to be detected is determined to be the direction signal.

19. The switching system of claim 16, wherein the sensing unit which is set in the earphone is a gyro sensor.

20. The switching system of claim 16, wherein the earphone connects with the electronic device in a wireless manner.
